(19) United States
(12) Patent Application Publication
(10) Pub. No.: US 2024/0320008 A1
(43) Pub. Date: Sep. 26, 2024

(54) VARIABLE HISTORY LENGTH PERCEPTRON BRANCH PREDICTOR

(71) Applicant: Huawei Technologies Co., Ltd., Shenzhen (CN)

(72) Inventors: Fangping Liu, San Jose, CA (US); Sang Wook Do, San Jose, CA (US); Richard Van, San Jose, CA (US)

(73) Assignee: Huawei Technologies Co., Ltd., Shenzhen (CN)

(21) Appl. No.: 18/680,778

(22) Filed: May 31, 2024

Related U.S. Application Data
(63) Continuation of application No. PCT/US2021/061364, filed on Dec. 1, 2021.

(51) Int. Cl. G06F 9/38; G06F 9/32

(52) U.S. Cl. CPC G06F 9/3844; G06F 9/321

(57) ABSTRACT

The present disclosure related to perceptron based branch prediction methods, devices, and systems. One example method includes storing, in a memory, multiple perceptron tables, determining, based on a branch program counter (PC) and a branch history and from among the multiple perceptron tables, a perceptron stored in a first perceptron table, obtaining weights of the perceptron stored in the first perceptron table, determining, based on the weights and the branch history, a branch prediction indicating a prediction of a direction that a branch will take upon instruction execution, and obtaining one or more instructions based on the predicted direction. Each perceptron table of the multiple perceptron tables has a different branch history length and a different tag length.

### CLAIM OF PRIORITY

This application is a continuation of, and claims priority to, PCT Patent Application No. PCT/US2021/061364, entitled “VARIABLE HISTORY LENGTH PERCEPTRON BRANCH PREDICTOR”, filed Dec. 1, 2021, which application is incorporated by reference herein in its entirety.

### TECHNICAL FIELD

This disclosure relates to branch prediction design of CPU architecture design and, more particularly, to variable history length perceptron based branch prediction.

### BACKGROUND

Branch prediction is a feature of modern computer architecture, which relies on speculation to boost instruction-level parallelism. Branch predication can speed execution of instructions on processors that use pipelining.

Branch prediction can be implemented in hardware (e.g., a processor) using a branch predictor. A branch predictor can be a digital circuit that predicts which path a branch (such as an if—then—else structure) will take before the branch is executed. Based on the branch prediction, a pipelined processor can speculatively fetch and execute instructions along the predicted path to prevent pipeline stalls by not waiting for the branch instruction to reach the execution stage. Published perceptron based branch predictors generally use a single perceptron table and fixed length branch history for branch prediction.

### SUMMARY

Perceptron based branch prediction uses perceptron(s) in neural networks to learn branch behavior, and can provide accurate branch prediction. For example, a perceptron can be used to learn correlations between particular branch directions in global branch history and behavior of a current branch. The correlations can be represented by weights. The larger the weight of a particular branch direction, the larger the influence that particular branch direction has on the prediction of the current branch. Perceptrons can be stored in a perceptron table. A branch program counter (PC) and/or a branch history can be used to index a corresponding perceptron stored in the perceptron table.

This specification includes descriptions of systems, software, and computer-implemented methods for variable history length perceptron based branch prediction. In one aspect, a method for perceptron based branch prediction includes storing, in a memory, a plurality of perceptron tables, wherein each perceptron table of the plurality of perceptron tables has a different branch history length and a different tag length, determining, based on a branch PC and a branch history and from among the plurality of perceptron tables, a perceptron stored in a first perceptron table, obtaining weights of the perceptron stored in the first perceptron table, determining, based on the weights and the branch history, a branch prediction, wherein the branch prediction indicates a prediction of a direction that a branch will take upon instruction execution, and obtaining one or more instructions based on the predicted direction.

Other implementations of this aspect include corresponding systems, apparatus, and computer programs, configured to perform the actions of the methods, encoded on computer storage devices. These and other embodiments can each optionally include one or more of the following features.

In some implementations, one of the plurality of perceptron tables has a zero-length tag, and all other perceptron tables have non-zero-length tags.

In some implementations, determining the perceptron can include, for each perceptron table of the plurality of perceptron tables, generating, based on the branch PC and the branch history, a corresponding index and a corresponding tag, wherein the corresponding index indicates an entry in the perceptron table, and determining a corresponding tag matching result, wherein the corresponding tag matching result indicates a tag match if the corresponding tag matches a tag of the entry indicated by the corresponding index or no tag match if the corresponding tag does not match the tag of the entry indicated by the corresponding index, and determining the perceptron based on the plurality of tag matching results.

In some implementations, if only one perceptron table has a tag matching result indicating a tag match, the perceptron is determined from the only one perceptron table.

In some implementations, if two or more perceptron tables have a tag matching result indicating a tag match, the perceptron is determined from a perceptron table with a highest branch history length in the two or more perceptron tables.

In some implementations, the corresponding tag generated for the perceptron table with the zero-length tag is zero.

In some implementations, after a direction of the branch is determined, the method further includes updating the weights of the perceptron stored in the first perceptron table based on the determined branch direction, the branch prediction, and a training threshold, and creating a new perceptron in response to a grouping condition being satisfied.

In some implementations, the grouping condition includes the following conditions: (1) the determined branch direction is different from the branch prediction, (2) a prediction magnitude is greater than or equal to a direction threshold, and (3) a branch history length of the first perceptron table is not the highest in the plurality of perceptron tables.

In some implementations, creating the new perceptron comprises creating the new perceptron in a different perceptron table having a non-zero-length tag if the first perceptron table has a zero-length tag, or creating the new perceptron in a different perceptron table with a branch history length that is higher than a branch history length of the first perceptron table, if the first perceptron table has a non-zero-length tag.

In some implementations, the method further includes relocating, based on a number of the weights of the perceptron, the perceptron to a different perceptron table with a branch history length that is lower than a branch history length of the first perceptron table.

The present disclosure also provides non-transitory computer-readable media coupled to one or more processors and having instructions stored thereon which, when executed by the one or more processors, cause the one or more processors to perform operations in accordance with implementations of the methods provided herein.

The present disclosure further provides a system for implementing the methods provided herein. The system includes one or more processors, and one or more non-transitory computer-readable media coupled to the one or more processors and having instructions stored thereon which, when executed by the one or more processors, cause the one or more processors to perform operations in accordance with implementations of the methods provided herein.

The subject matter described in this specification can be implemented in particular embodiments to realize one or more of the following advantages. The techniques described in this specification enables a perceptron branch predictor to use multiple perceptron tables with different lengths of branch history, instead of a single perceptron table with fixed length of branch history, for branch prediction. By using perceptrons of different history lengths for different branches, the number of perceptrons allowed under a same memory budget can be increased, thereby improving branch prediction accuracy. In addition, perceptrons are normally shared by multiple branches. When branches of opposite directions share a same perceptron, it is difficult to perform perceptron training based on the opposite directions (i.e., adversary effect of aliasing). By using branch tagging and grouping to move branches of different directions to different perceptron tables, adversary effect of aliasing can be reduced and branch prediction accuracy can be improved with the perceptron training. Further, by relocating a branch to a perceptron table with a branch history length that is lower than a branch history length of a perceptron table in which the branch is currently located, perceptron table space can be used efficiently, thereby reducing memory budget.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE FIGURES

FIG. 1 is a block diagram illustrating an example device for perceptron based branch prediction.

FIG. 2 is a diagram of an example process for multiple perceptron table lookup.

FIG. 3 is a flow diagram of an example process for perceptron training.

FIG. 4 is an example view of example perceptron tables for branches placement.

FIG. 5 is a flow diagram of an example process for perceptron based branch prediction.

FIG. 6 is a schematic diagram of an example microprocessor based computing device on which perceptron based branch prediction can be implemented.

FIG. 7 is a schematic diagram of a general purpose network component or computer system.

Like reference numbers and designations in the various drawings indicate like elements.

### DETAILED DESCRIPTION

The following detailed description describes variable history length perceptron based branch prediction and is presented to enable a person skilled in the art to make and use the disclosed subject matter in the context of one or more particular implementations.

Various modifications, alterations, and permutations of the disclosed implementations can be made and will be readily apparent to those of ordinary skill in the art, and the general principles defined may be applied to other implementations and applications, without departing from the scope of the disclosure. In some instances, details unnecessary to obtain an understanding of the described subject matter may be omitted so as to not obscure one or more described implementations with unnecessary detail inasmuch as such details are within the skill of one of ordinary skill in the art. The present disclosure is not intended to be limited to the described or illustrated implementations, but to be accorded the widest scope consistent with the described principles and features.

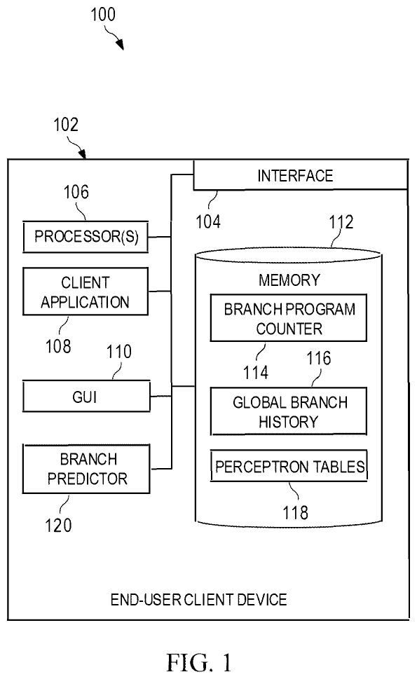

The present disclosure describes example implementations of variable history length perceptron based branch prediction. In the present disclosure, and as described in greater detail with reference to FIGS. 1-5, a branch predictor (e.g., a processor or instructions/software component executed by a processor) can determine, based on a branch program counter (PC) and a branch history and from among multiple perceptron tables stored in a memory, a perceptron stored in a first perceptron table, obtain weights of the perceptron stored in the first perceptron table, determine, based on the weights and the branch history, a branch prediction indicating a prediction of a direction that a branch will take upon instruction execution, and obtain one or more instructions based on the predicted direction. For example, the direction of a branch is either taken or not taken, and the outcome of the branch instruction is either jumping to the branch target PC or following through to the next instruction after the current branch instruction in memory space. Each perceptron table of the multiple perceptron tables has a different branch history length and tag length configuration.

FIG. 1 is a block diagram illustrating an example device 100 for perceptron based branch prediction. Specifically, the illustrated device 100 includes an end-user client device 102. In general, the end-user client device 102 is an electronic computer device operable to receive, transmit, process, and store any appropriate data associated with the device 100 of FIG. 1. As shown in FIG. 1, the end-user client device 102 can include an interface 104, one or more processor(s) 106, a client application 108, a graphical user interface (GUI) 110, memory 112, and a branch predictor 120.

The end-user client device 102 (also referred to herein as client device 102 or device 102) includes any client computing device such as a laptop/notebook computer, wireless data port, smart phone, personal data assistant (PDA), tablet computing device, one or more processors within these devices, or any other suitable processing device. For example, the end-user client device 102 can include, e.g., a computer that includes an input device, such as a keypad, touch screen, or other device that can accept user information, and an output device that conveys information.

The interface 104 is used by the end-user client device 102 for communicating with other devices or systems in a distributed environment. Generally, the interface 104 includes logic encoded in software and/or hardware in a suitable combination and operable to communicate with a network (not shown in FIG. 1). More specifically, the interface 104 can include software supporting one or more communication protocols associated with communications such that the network or interface's hardware is operable to communicate physical signals within and outside of the illustrated device 100.

The client device 102 include one or more processor(s) 106. Each processor 106 can be a central processing unit (CPU), an application specific integrated circuit (ASIC), a field-programmable gate array (FPGA), or another suitable component. Generally, each processor 106 executes instructions and manipulates data to perform the operations of the end-user client device 102. Specifically, each processor 106 executes the functionality required to run the client application 108, for example.

The end-user client device 102 typically includes one or more applications, such as the client application 108. The client application 108 is any type of application that allows the end-user client device 102 to request and view content on a respective client device. Examples of content presented at a client device 102 include compilers, interpreters, source code editors, integrated development environments (IDEs), webpages, word processing documents, portable document format (PDF) documents, images, and videos.

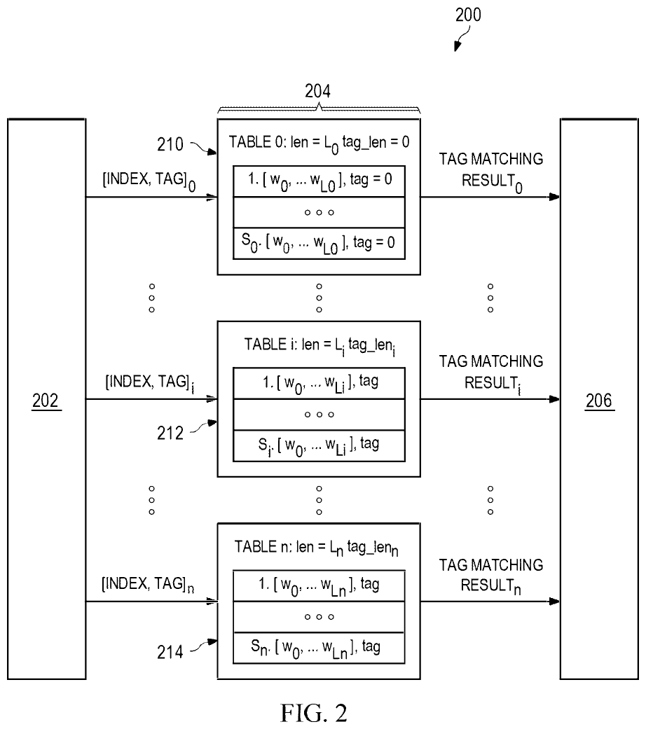

As described further with reference to FIGS. 2-5, an end user of the end-user client device 102 may desire to use the branch predictor 120 to carry out one or more tasks associated with branch prediction. For example, when the end user of the client device 102 launches the client application 108 on the client device 102 and a branch is encountered while running the client application 108, the client device 102 can interface with and accesses the branch predictor 120 to predict which path the branch will take. Once the predicted path is obtained from the branch predictor 120, the client device 102 can speculatively fetch and execute instructions along the predicted path. The end user client device 102 provides the client application 108 for display within the GUI 110.

The GUI 110 interfaces with at least a portion of the end-user client device 102 for any suitable purpose, including generating and/or displaying a visual representation (or data that provides a visual representation) provided by the end-user client device 102. Generally, the GUI 110 provides a user with an efficient and user-friendly presentation of data provided by or communicated within the end-user client device 102. The GUI 110 may have multiple customizable frames or views having interactive fields, pull-down lists, and buttons operated by the user. The GUI 110 contemplates any suitable graphical user interface, such as a combination of a generic web browser, intelligent engine, and command line interface (CLI) that processes information and efficiently presents the results to the user visually.

The end-user client device 102 includes the memory 112. In some implementations, the end-user client device 102 includes multiple memories. The memory 112 may include any type of memory or database module and may take the form of volatile and/or non-volatile memory including, without limitation, magnetic media, optical media, random access memory (RAM), read-only memory (ROM), removable media, or any other suitable local or remote memory component. The memory 112 may store various objects or data, including video files, metadata, caches, classes, frameworks, applications, backup data, business objects, jobs, web pages, web page templates, database tables, database queries, repositories storing business and/or dynamic information, and any other appropriate information including any parameters, variables, algorithms, instructions, rules, constraints, or references thereto associated with the purposes of the end-user client device 102.

The memory 112 includes branch program counter 114 (also referred to herein as branch PC 114), global branch history 116, and perceptron tables 118. The branch PC 114 can be an address of a branch instruction, which is part of an instruction sequence. A direction of the branch (e.g., which specifies whether the branch is taken or not taken) is predicted before the branch is executed. For example, if the predicted direction is not taken, the next instruction in the instruction sequence is executed. If the predicted direction is taken, the branch target (e.g., an instruction along the predicted direction), instead of the next instruction, is executed. The global branch history 116 can be a register (such as a Global History Register (GHR)) that records previous directions of multiple branches. For example, a given branch having an 8-bit history of (1 −1 −1 1 1 −1 1 1) in the global branch history 116 indicates that the eight previous directions of the given branch were taken, not taken, not taken, taken, taken, not taken, taken, taken. In some implementation, (1 −1 −1 1 1 −1 1 1) can be stored as (1 0 0 1 1 0 1 1) in binary format. The perceptron tables 118 include multiple perceptron tables, each with a different branch history length and tag length configuration (as described with reference to FIG. 2). Each perceptron table includes one or more perceptron entries. A perceptron entry can be used to store a number of weights for an associated perceptron. The branch PC 114 and the global branch history 116 can be used to index the perceptron tables 118 using, for example, a hash function.

The end-user client device 102 includes the branch predictor 120. The branch predictor 120 can provide functionality associated with perceptron based branch prediction. For example, when a branch is encountered while executing an instruction sequence, a pipelined processor can use the branch predictor 120 to predict which path the branch will take and speculatively fetch and execute instructions along the predicted path. A branch PC and branch history are obtained, respectively, from the branch PC 114 and the global branch history 116, and are input to the branch predictor 120. Based on the input branch PC and the input branch history, the branch predictor 120 determines a perceptron table from among the multiple perceptron tables 118 and obtains a perceptron stored in the determined perceptron table. The branch predictor 120 then obtains weights of the perceptron stored in the perceptron table, and uses the weights to make a branch prediction. Although shown separately from the one or more processors 106, in some implementations, the branch predictor 120 can be implemented as a set of instructions that are stored in memory 112 and executed by the one or more processors 106. In some implementations, the branch predictor 120 may comprise multiple components performing multiple functions of the branch predictor 120 in parallel or in serial.

There may be any number of end-user client devices 102 associated with, or external to, the device 100. For example, while the illustrated device 100 includes one end-user client device 102, alternative implementations of the device 100 may include multiple end-user client devices 102, or any other number suitable to the purposes of the device 100. Additionally, there may also be one or more additional end-user client devices 102 external to the illustrated portion of device 100 that are capable of interacting with the device 100 via a network. Further, the term “client,” “client device,” and “user” may be used interchangeably as appropriate without departing from the scope of this disclosure. Moreover, while the end-user client device 102 may be described in terms of being used by a single user, this specification contemplates that many users may use one computer, or that one user may use multiple computers.

FIG. 2 is a diagram of an example process 200 for multiple perceptron table lookup. Operations of process 200 are described below as being performed by the components of the device, such as the branch predictor 120, described and depicted in FIG. 1. Operations of the process 200 are described below for illustration purposes only. Operations of the process 200 can be performed by any appropriate device or system, e.g., any appropriate data processing apparatus. Operations of the process 200 can also be implemented as instructions stored on a non-transitory computer readable medium. Execution of the instructions causes one or more data processing apparatus to perform operations of the process 200.

As shown in FIG. 2, there are n+1 perceptron tables in this example, namely Table 0 210 to Table n 214. n is a positive integer, which can be configured by, for example, the branch predictor 120 of FIG. 1. Each perceptron table has a different branch history length and tag length configuration. For example, Table i 212 has a fixed branch history length Lᵢ and a fixed tag length tag_lenᵢ, where 1≤i≤n−1. Among the n+1 perceptron tables, there is a perceptron table having a lowest history length. In addition, the perceptron table having the lowest history length is configured to have a zero-length tag. In this example, Table 0 210 has the lowest history length among the n+1 perceptron tables, and therefore has a zero-length tag (e.g., tag_len=0, which indicates that the table has no tag information). For example, tag for each entry in the perceptron table with a zero-length tag configuration can be set to 0 (tag=0). Other perceptron tables have non-zero-length tags (tag_len≠0, which indicates that there is tag information). For example, a non-zero-length tag is a number with fixed length. The tag for an entry in a perceptron table with a non-zero-length tag configuration can be calculated using a hash function on branch history with a length, which is the same as a branch history length of the perceptron table. Each perceptron table includes one or more perceptron entries. Each perceptron entry can be used to store a number of weights (such as [w₀, . . . , w_{L}_{ᵢ}]) for the associated perceptron. For example, Table i 212 has a table size Sᵢ that can store Sᵢ perceptron entries. Sᵢ is a positive integer, which can be configured by, for example, the branch predictor 120.

At step 202, a branch PC and a branch history are provided by, for example the one or more processors 106, to perform branch prediction. The branch PC is an address of a branch instruction, which is part of an instruction sequence. Before the branch instruction is executed, a direction of the branch instruction is predicted to prevent pipeline stalls by not waiting for the branch instruction to reach the execution stage. The branch history provides previous actual directions of the branch instruction. The branch PC and the branch history are mapped to n+1 [index, tag] pairs, namely [index, tag]₀ to [index, tag]ₙ, one for each perceptron table. For example, for any perceptron table in the n+1 perceptron tables, the branch PC, the branch history, and at least one of table identifier, table size, or tag length of the particular perceptron table can be hashed into an [index, tag] pair for the particular perceptron table. In some implementations, the index in the [index, tag] pair can be bound by the table size of the perceptron table. The tag in the [index, tag] pair can be configured with the tag length of the perceptron table. In some implementations, step 202 is performed by a mapping component (e.g., a software component or function including instructions that are executed by a processor) of the branch predictor 120.

At step 204, the n+1 [index, tag] pairs are compared with the n+1 perceptron tables to produce n+1 tag matching results, namely tag matching result₀ to tag matching resultₙ. For example, the [index, tag]ᵢ pair is compared with the branch history length and tag length configuration of Table i 212 to produce the tag matching results. First, the index in the [index, tag]ᵢ pair is compared with perceptron entry indexes (1, . . . , Sᵢ) in the Table i 212 to identify a perceptron entry with an index same as the index in the [index, tag]ᵢ pair. (1, . . . , Sᵢ) are used as example indexes for the Table i 212. Other indexes that can uniquely identify each perceptron entry can be used in a perceptron table. Then, the tag in the [index, tag]ᵢ pair is compared with a tag in the Table i 212 stored with the identified perceptron entry to produce a tag matching result. If the tag in the [index, tag]ᵢ pair matches the tag of the identified perceptron entry, a tag matching result indicating a tag match is determined for Table i 212. If the tag in the [index, tag]ᵢ pair does not match the tag of the identified perceptron entry, a tag matching result indicating no tag match is determined for Table i 212. Since a perceptron table with a zero-length tag (Table 0 210 in this example) has no tag information, it will always have a tag matching result indicating a tag match. In some implementations, step 204 is performed by a lookup component (e.g., a software component or function including instructions that are executed by a processor) of the branch predictor 120.

At step 206, the n+1 tag matching results are compared to produce a winning perceptron. For example, if one or more perceptron tables with non-zero-length tags have a tag matching result indicating a tag match, a perceptron table with the highest branch history length among the one or more perceptron tables with non-zero-length tags is chosen as a winning perceptron table, and the matching perceptron entry in the winning perceptron table is chosen as the winning perceptron. In other words, history lengths can be used to indicate priorities among the perceptron tables. A perceptron table with higher branch history length will have higher priority. If none of the perceptron tables with non-zero-length tags has a tag matching result indicating a tag match, the matching perceptron entry in the perceptron table with a zero-length tag (Table 0 210 in this example) is chosen as the winning perceptron. In some implementations, step 206 is performed by an arbitrator (e.g., a software component or function including instructions that are executed by a processor) of the branch predictor 120.

After the winning perceptron is determined, the branch predictor 120 obtains weights of the winning perceptron for branch prediction. The branch predictor 120 can support perceptrons with different configured branch history lengths. For example, if the winning perceptron is determined from Table i 212 with weights of [w₀ , . . . , w_{L}_{ᵢ}] and a branch history vector ([x₀, . . . , x_{L}_{ᵢ}]) is obtained from the branch history (as input at step 202), the branch prediction can be determined as:

$$y = {\sum }_{j = 0}^{{L}_{i}} {x}_{j} {w}_{j} \qquad ( 1 )$$

As shown in Equation (1), prediction output y is a dot product of the branch history vector and the weights. When making the branch prediction, sign of y determines the direction. The branch is predicted as not taken when y is negative, or the branch is predicted as taken when y is positive or equal to 0. Magnitude of strength of y (|y|) indicates a confidence of the corresponding prediction. For example, |y|=0 or 1 indicates a low confidence, and |y|=10 indicates a high confidence.

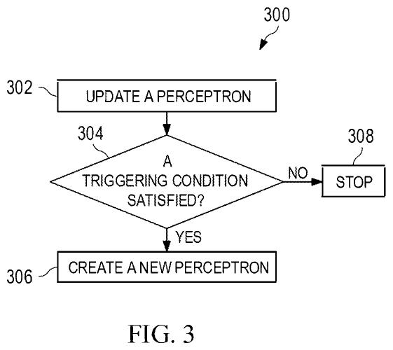

FIG. 3 is a flow diagram of an example process 300 for perceptron training. Operations of process 300 are described below as being performed by the components of the device, such as the branch predictor 120, described and depicted in FIG. 1. Operations of the process 300 are described below for illustration purposes only. Operations of the process 300 can be performed by any appropriate device or system, e.g., any appropriate data processing apparatus. Operations of the process 300 can also be implemented as instructions stored on a non-transitory computer readable medium. Execution of the instructions causes one or more data processing apparatus to perform operations of the process 300.

After a direction of the branch is determined (e.g., when the branch instruction is executed and retired), at step 302, the winning perceptron from the winning perceptron table used for the branch prediction is updated as follows:

```
if sign(y) ≠ t or |y| ≤ θₜ then
  for i := 0 to l do
    wᵢ := wᵢ + txᵢ
  end for
end if
```

where y is the prediction output described in FIG. 2; t is the determined branch direction; θₜ is a training threshold (such as a parameter used to decide when enough training has been done); wᵢ is an i^{th} weight of the perceptron; l is a branch history length; xᵢ is an i^{th} component of the branch history (x₀ is a “bias” input and is set to 1). For example, t=1 indicates that the branch is taken, and t=−1 (or t=0 in binary format) indicates that the branch is not taken. In an 8-bit history of (1 −1 −1 1 1 −1 1 1), the right most 1 represents the 1^{st} component, and the left most 1 represents the 8^{th} component. In some implementations, (1 −1 −1 1 1 −1 1 1) can be stored as (1 0 0 1 1 0 1 1) in binary format. If the determined branch direction (t) is different from the predicted branch direction (sign (y)) or a prediction magnitude (|y|) is less than or equal to the training threshold (θₜ), each weight component (wᵢ) of the winning perceptron is increase by a factor of txᵢ.

The training process finds correlations between branch history used for the prediction and the determined branch direction. In other words, the most recent branch prediction and the most recent branch direction are used to train the perceptron used for the prediction by updating weights of the perceptron. If t and xᵢ take values of either −1 or 1, the i^{th} weight increments by 1 when the determined branch direction, t, agrees with xᵢ, and decrements by 1 when the determined branch direction, t, disagrees with xᵢ. In other words, weight increases when there is positive correction between t and x, and weight with large positive value has a large influence on the prediction (effective weight). Weight decreases when there is negative correction between t and x, and weight with large negative value also has a large influence on the prediction (effective weight). When there is weak correlation between t and x, weight remains close to 0 and has a small influence on the prediction (ineffective weight).

In some implementations, a branch grouping process can be performed after the training process. For example, a determination is made as to whether a grouping condition is satisfied at step 304. If yes, a new perceptron is created at step 306 (branch grouping). Otherwise, the process 300 stops at step 308. For example, the grouping condition includes the following conditions: (1) the determined branch direction (t) is different from the predicted branch direction (sign (y)), (2) a prediction magnitude (|y|) reaches a direction threshold (θ_{d}), and (3) the perceptron used for branch prediction has a history length less than the highest configured history length among the perceptron tables. In some implementations, the direction threshold (θ_{d}) is about four times of the training threshold (θₜ). If all three conditions are satisfied, a procedure to create a new perceptron for the branch is triggered. In other words, the perceptron used for branch prediction does not provide accurate prediction for the branch, and a new perceptron needs to be created for the branch in a higher priority perceptron table.

To create the new perceptron, the new perceptron creation procedure searches perceptron tables with higher priorities (higher history length) than the perceptron table from which the winning perceptron is chosen for an available entry. For example, if the current perceptron table has a zero-length tag, perceptron tables with non-zero-length tags are searched. If the current perceptron table has a non-zero-length tag, perceptron tables with higher branch history lengths than the current perceptron table are searched.

When an available entry (such as an empty entry or an inactive entry (e.g., an entry that is not used or updated in a predetermined time period)) is found in one or more perceptron tables, a perceptron table with the highest branch history length among the one or more perceptron tables is chosen, and the new perceptron is created at the available entry in the chosen perceptron table. The new perceptron is created with a new index and a new tag. For example, if the new perceptron is created in table i, the new perceptron is created with the [index, tag]ᵢ pair as described in FIG. 2.

In some implementations, when an available entry is not found in the searched perceptron tables, the new perceptron creation procedure can randomly pick one entry from one of the searched perceptron tables, age the entry, and create a new entry with the new index and the new tag.

In this manner, this branch grouping process allows for branches with same branch direction to be grouped together, thereby alleviating aliasing problem and improving prediction accuracy.

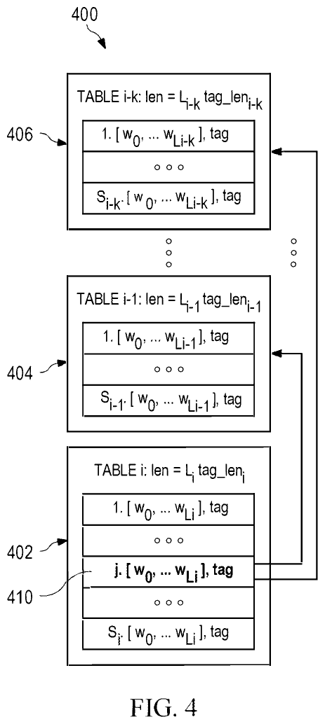

FIG. 4 is an example view of example perceptron tables 400 for branches placement. The example perceptron tables 400 are for illustration purposes only, and may include additional and/or different tables not shown in FIG. 4. As described in FIG. 3, perceptrons are likely to be moved to perceptron tables with higher priorities compared to the table within which a current perceptron resides (e.g., tables with higher branch history lengths compared to the table within which the current perceptron resides).

In general, perceptron tables with higher priorities (e.g., higher branch history lengths) are filled up prior to filling up perceptron tables with relatively lower priorities (e.g., lower branch history lengths). For better table usage, it is advantageous to move some perceptrons (e.g., perceptrons that can be stored in perceptron tables with low priorities) out of the perceptron tables with high priorities, and to free up some space for future new perceptrons.

During a perceptron training process (described in FIG. 3), effective weights (as described below) of a perceptron used for current branch prediction are determined. For example, after weights of the perceptron are updated (as described in FIG. 3), weights that have large influence on the prediction are counted. In some implementations, the weights that have a large influence on the branch prediction are those that have absolute values larger than a threshold. In such implementations, the weights with absolute values that are larger than a threshold are counted as effective weights. If the number of effective weights (an effective branch history length) of the perceptron is lower than one or more configured branch history lengths of one or more perceptron tables, an attempt is made to relocate the perceptron to a perceptron table with a configured branch history length lower than a perceptron table in which the perceptron is currently located.

As shown in FIG. 4, Table i 402, Table i−1 404, and Table i−k 406 are sorted in ascending order based on their configured branch history lengths (Lᵢ₋ₖ< . . . <Lᵢ₋₁<Lᵢ), where k≤i. As such, table 406 has a lower configured branch history length compared to table 404, which in turn has a lower configured branch history length compared to table 402.

Perceptron 410 is used for current branch prediction and is located in Table i 402 (which has the higher configured branch history length compared to those of tables 404 and 406). After the weights of the perceptron 410 are updated (as described with reference to FIG. 3), the perceptron 410's effective branch history length is computed (as per the preceding paragraphs) and determined to be lower than the configured branch history lengths Lᵢ, Lᵢ₋₁, . . . , Lᵢ₋ₖ of Table i 402, Table i−1 404, . . . , Table i−k 406. In response to this determination, the perceptron 410 is attempted to be moved from Table i 402 to one of Table i−1 404, . . . , Table i−k 406. For example, indices for Table i−1 404, . . . , Table i−k 406 are obtained from the [index, tag] pairs generated during branch prediction as described in FIG. 2. The table entry with indexᵢ₋₁ in Table i−1 404, . . . , the table entry with indexᵢ₋ₖ in Table i−k 406 are checked to determine if they are available entries (such as empty entries or inactive entries (e.g., entries that are not used or updated in a predetermined time period)). If it is determined that there are one or more consecutive tables (e.g., from Table i−1, . . . , to Table i−m, 1≤m≤k) each with an available entry (e.g., an available entry with indexᵢ₋₁ in Table i−1, . . . , an available entry with indexᵢ₋ₘ in Table i−m), the perceptron 410 is moved to the entry with indexᵢ₋ₘ in Table i−m, which has the lowest configured branch history length among the one or more consecutive tables. In some implementations, after the perceptron 410 is moved, the table entry in Table i 402 where the perceptron 410 is previously located becomes an available entry. If it is determined that there is no available entry in Table i−1 404, . . . , Table i−k 406, the attempt to relocate the perceptron 410 stops, and the perceptron 410 is maintained in its current perceptron Table i 402.

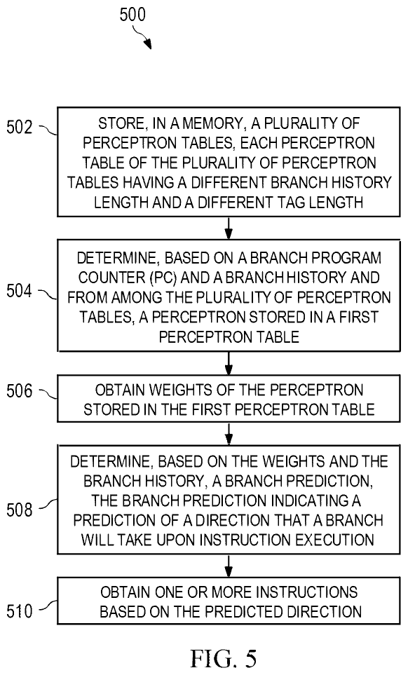

FIG. 5 is a flow diagram of an example process 500 for perceptron based branch prediction. Operations of process 500 are described below as being performed by the components of the device, such as the branch predictor 120, described and depicted in FIG. 1. Operations of the process 500 are described below for illustration purposes only. Operations of the process 500 can be performed by any appropriate device or system, e.g., any appropriate data processing apparatus. Operations of the process 500 can also be implemented as instructions stored on a non-transitory computer readable medium. Execution of the instructions causes one or more data processing apparatus to perform operations of the process 500. In some implementations, various steps of the process 500 can be run in parallel, in combination, in loops, or in any order.

The process 500 includes storing, in a memory, multiple perceptron tables (at step 502). Each perceptron table of the multiple perceptron tables has a different branch history length and a different tag length, which can be pre-configured by, for example, the branch predictor 120. In some implementations, one of the multiple perceptron tables has a zero-length tag, and all other perceptron tables have non-zero-length tags. For example, tag for each entry in the perceptron table having the zero-length tag is set to 0. Tag for an entry in a perceptron table having the non-zero-length tag is a number with a fixed length, which is the same as the branch history length of the perceptron table. In some implementations, a tag is stored with an entry in a perceptron table.

A perceptron (e.g., a winning perceptron) stored in a first perceptron table (e.g., a winning perceptron table) is determined based on a branch PC and a branch history and from among the multiple perceptron tables (at step 504). The branch PC is an address of a branch instruction, and the branch history includes values representing the previous directions of the branch instruction.

In some implementations, for each perceptron table of the multiple perceptron tables, a corresponding index and a corresponding tag are generated based on the branch PC and the branch history, and a corresponding tag matching result is determined based on the corresponding index and tag. The corresponding index indicates an entry in each perceptron table. The corresponding tag matching result indicates a tag match if the corresponding tag matches a tag of the entry indicated by the corresponding index, or no tag match if the corresponding tag does not match the tag of the entry indicated by the corresponding index. In some implementations, a perceptron table with a zero-length tag will always produce a tag matching result indicating a tag match (e.g., the corresponding tag and a tag of any entry in the perceptron table with the zero-length tag always match). In some implementations, the corresponding tag generated for the perceptron table with the zero-length tag is zero. After all tag matching results are determined, the perceptron is determined based on the multiple tag matching results (as further described above with reference to FIG. 2).

In some implementations, if only one perceptron table has a tag matching result indicating a tag match, the perceptron is determined from the only one perceptron table. If two or more perceptron tables have a same tag matching result indicating a tag match, the perceptron is determined from a perceptron table with a highest branch history length in the two or more perceptron tables.

Weights of the perceptron stored in the first perceptron table are obtained (at step 506). For example, the branch predictor 120 can obtain the weights of the perceptron stored in the perceptron tables 118 (as further described above with reference to FIGS. 1 and 2). In some implementations, each perceptron table includes one or more entries (also referred to as perceptron entries), with perceptron entry including data for a particular perceptron. Each perceptron entry can be used to store a number of weights for the associated perceptron. Weights can represent correlations between particular branch directions in branch history and behavior of a current branch. The larger the weight of a particular branch direction, the larger influence that the particular branch direction has on the prediction of the current branch.

A branch prediction is determined based on the weights and the branch history (at step 508). The branch prediction indicates a prediction of a direction that a branch will take upon instruction execution. As further described above with reference to FIG. 2, the branch prediction can be determined based on a dot product (y) of the weights and the branch history (shown in Equation (1) above). For example, the branch is predicted as not taken when y is negative, or the branch is predicted as taken when y is positive or equal to 0.

One or more instructions are obtained based on the predicted direction (at step 510). For example, instead of waiting for a direction of a branch to be determined, a pipelined processor can pre-fetch and fetch instructions according to the predicted direction of the branch to prevent pipeline stalls.

In some implementations, after a direction of the branch is determined, the weights of the perceptron stored in the first perceptron table are updated based on the determined branch direction, the branch prediction, and a training threshold. After the weights are updated, a determination is made as to whether a grouping condition is satisfied. In In some implementations, the grouping condition includes the following conditions: (1) the determined branch direction is different from the branch prediction, (2) a prediction magnitude is greater than or equal to a direction threshold, and (3) a branch history length of the first perceptron table is not the highest in the plurality of perceptron tables. In response to the grouping condition being satisfied, a new perceptron is created. The new perceptron is created in a perceptron table with a higher branch history length than the first perceptron table (as further described above with reference to FIG. 3). For example, if the first perceptron table has a zero-length tag, the perceptron is created in a different perceptron table having a non-zero-length tag. If the first perceptron table has a non-zero-length tag, the perceptron is created in the different perceptron table with a higher branch history length than the first perceptron table.

In some implementations, at perceptron update time, the perceptron is relocated, based on a number of the weights, to a different perceptron table with a branch history length that is lower than a branch history length of the first perceptron table (as described above with reference to FIG. 4 and as further summarized below). In some implementations, the number of the weights only include weights that have large influence on the prediction. For example, weights that have absolute values larger than a threshold are counted in the number of the weights, which represent an effective branch history length of the perceptron. If the effective branch history length of the perceptron is lower than one or more configured branch history lengths of one or more perceptron tables, the perceptron is relocated to one of the one or more perceptron tables with a lower configured branch history length compared to the perceptron table within which the perceptron is currently stored.

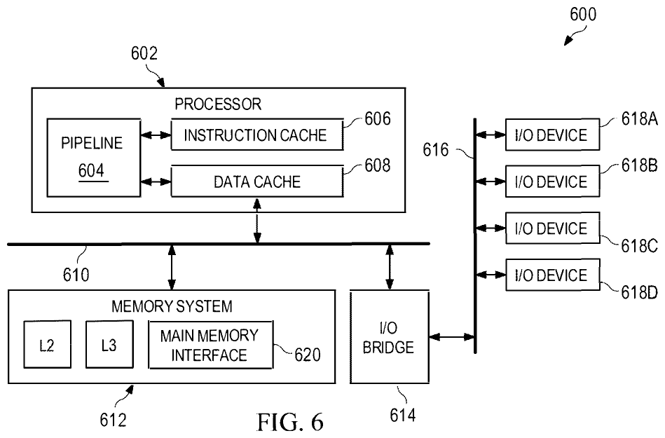

FIG. 6 is a schematic diagram of an example microprocessor based computing device 600 on which perceptron based branch prediction can be implemented. The techniques described in this specification can be implemented to run on the computing system to perform perceptron based branch prediction. The computing device 600 includes at least one processor 602, which could be a single central processing unit (CPU) or an arrangement of multiple processor cores of a multi-core architecture.

In the depicted example, the processor 602 includes a pipeline 604, an instruction cache 606, and a data cache 608 (and other circuitry, not shown). The processor 602 is connected to a processor bus 610, which enables communication with an external memory system 612 and an input/output (I/O) bridge 614. The I/O bridge 614 enables communication over an I/O bus 616, with various different I/O devices 618A-618D (e.g., disk controller, network interface, display adapter, and/or user input devices such as a keyboard or mouse).

The external memory system 612 is part of a hierarchical memory system that includes multi-level caches, including the first level (L1) instruction cache 606 and data cache 608, and any number of higher level (L2, L3, etc.) caches within the external memory system 612. Other circuitry (not shown) in the processor 602 supporting the caches 606 and 608 includes a translation lookaside buffer (TLB), various other circuitry for handling a miss in the TLB or the caches 606 and 608. For example, the TLB is used to translate an address of an instruction being fetched or data being referenced from a virtual address to a physical address, and to determine whether a copy of that address is in the instruction cache 606 or data cache 608, respectively. If so, that instruction or data can be obtained from the L1 cache. If not, that miss is handled by miss circuitry so that it may be executed from the external memory system 612. It is appreciated that the division between which level caches are within the processor 602 and which are in the external memory system 612 can differ in various examples. For example, an L1 cache and an L2 cache may both be internal and an L3 (and higher) cache could be external. The external memory system 612 also includes a main memory interface 620, which is connected to any number of memory modules (not shown) serving as main memory (e.g., Dynamic Random Access Memory modules).

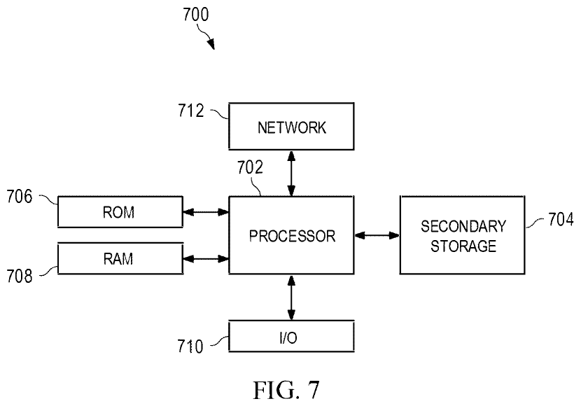

FIG. 7 is a schematic diagram of a general-purpose network component or computer system 700. The general-purpose network component or computer system 700 includes a processor 702 (which may be referred to as a central processor unit or CPU) that is in communication with memory devices including secondary storage 704, and memory, such as ROM 706 and RAM 708, input/output (I/O) devices 710, and a network 712, such as the Internet or any other well-known type of network, that may include network connectivity devices, such as a network interface. Although illustrated as a single processor, the processor 702 is not so limited and may comprise multiple processors. The processor 702 may be implemented as one or more CPU chips, cores (e.g., a multi-core processor), FPGAs, ASICS, and/or DSPs, and/or may be part of one or more ASICs. The processor 702 may be configured to implement any of the schemes described herein. The processor 702 may be implemented using hardware, software, or both.

The secondary storage 704 is typically comprised of one or more disk drives or tape drives and is used for non-volatile storage of data and as an over-flow data storage device if the RAM 708 is not large enough to hold all working data. The secondary storage 704 may be used to store programs that are loaded into the RAM 708 when such programs are selected for execution. The ROM 706 is used to store instructions and perhaps data that are read during program execution. The ROM 706 is a non-volatile memory device that typically has a small memory capacity relative to the larger memory capacity of the secondary storage 704. The RAM 708 is used to store volatile data and perhaps to store instructions. Access to both the ROM 706 and the RAM 708 is typically faster than to the secondary storage 704. At least one of the secondary storage 704 or RAM 708 may be configured to store branch PC, global branch history, perceptron tables, or other information disclosed herein.

It is understood that by programming and/or loading executable instructions onto the general-purpose network component or computer system 700, at least one of the processor 702 or the memory (e.g. ROM 706, RAM 708) are changed, transforming the general-purpose network component or computer system 700 in part into a particular machine or apparatus, e.g., a router, having the novel functionality taught by the present disclosure. Similarly, it is understood that by programming and/or loading executable instructions onto the general-purpose network component or computer system 700, at least one of the processor 702, the ROM 706, and the RAM 708 are changed, transforming the general-purpose network component or computer system 700 in part into a particular machine or apparatus, e.g., a router, having the novel functionality taught by the present disclosure. It is fundamental to the electrical engineering and software engineering arts that functionality that can be implemented by loading executable software into a computer can be converted to a hardware implementation by well-known design rules. Decisions between implementing a concept in software versus hardware typically hinge on considerations of stability of the design and numbers of units to be produced rather than any issues involved in translating from the software domain to the hardware domain. Generally, a design that is still subject to frequent change may be preferred to be implemented in software, because re-spinning a hardware implementation is more expensive than re-spinning a software design. Generally, a design that is stable that will be produced in large volume may be preferred to be implemented in hardware, for example in an ASIC, because for large production runs the hardware implementation may be less expensive than the software implementation. Often a design may be developed and tested in a software form and later transformed, by well-known design rules, to an equivalent hardware implementation in an application specific integrated circuit that hardwires the instructions of the software. In the same manner as a machine controlled by a new ASIC is a particular machine or apparatus, likewise a computer that has been programmed and/or loaded with executable instructions may be viewed as a particular machine or apparatus.

The technology described herein can be implemented using hardware, firmware, software, or a combination of these. The software used is stored on one or more of the processor readable storage devices described above to program one or more of the processors to perform the functions described herein. The processor readable storage devices can include computer readable media such as volatile and non-volatile media, removable and non-removable media. By way of example, and not limitation, computer readable media may comprise computer readable storage media and communication media. Computer readable storage media may be implemented in any method or technology for storage of information such as computer readable instructions, data structures, program modules or other data. Examples of computer readable storage media include RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by a computer. A computer readable medium or media does (do) not include propagated, modulated or transitory signals.

Communication media typically embodies computer readable instructions, data structures, program modules or other data in a propagated, modulated or transitory data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as RF and other wireless media. Combinations of any of the above are also included within the scope of computer readable media.

In alternative embodiments, some or all of the software can be replaced by dedicated hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), special purpose computers, etc. In one embodiment, software (stored on a storage device) implementing one or more embodiments is used to program one or more processors. The one or more processors can be in communication with one or more computer readable media/storage devices, peripherals and/or communication interfaces.

It is understood that the present subject matter may be embodied in many different forms and should not be construed as being limited to the embodiments set forth herein. Rather, these embodiments are provided so that this subject matter will be thorough and complete and will fully convey the disclosure to those skilled in the art. Indeed, the subject matter is intended to cover alternatives, modifications and equivalents of these embodiments, which are included within the scope and spirit of the subject matter as defined by the appended claims. Furthermore, in the following detailed description of the present subject matter, numerous specific details are set forth in order to provide a thorough understanding of the present subject matter. However, it will be clear to those of ordinary skill in the art that the present subject matter may be practiced without such specific details.

Aspects of the present disclosure are described herein with reference to flowchart illustrations and/or block diagrams of methods, apparatuses (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to best explain the principles of the disclosure and the practical application, and to enable others of ordinary skill in the art to understand the disclosure with various modifications as are suited to the particular use contemplated.

For purposes of this document, each process associated with the disclosed technology may be performed continuously and by one or more computing devices. Each step in a process may be performed by the same or different computing devices as those used in other steps, and each step need not necessarily be performed by a single computing device.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A computer-implemented method, comprising:
storing, in a memory, a plurality of perceptron tables, wherein each perceptron table of the plurality of perceptron tables has a different branch history length and a different tag length;
determining, based on a branch program counter (PC) and a branch history and from among the plurality of perceptron tables, a perceptron stored in a first perceptron table;
obtaining weights of the perceptron stored in the first perceptron table;
determining, based on the weights and the branch history, a branch prediction, wherein the branch prediction indicates a prediction of a direction that a branch will take upon instruction execution; and
obtaining one or more instructions based on the predicted direction.

2. The computer-implemented method according to claim 1, wherein one of the plurality of perceptron tables has a zero-length tag, and all other perceptron tables have non-zero-length tags.

3. The computer-implemented method according to claim 1, wherein determining the perceptron comprises:
for each perceptron table of the plurality of perceptron tables:
generating, based on the branch PC and the branch history, a corresponding index and a corresponding tag, wherein the corresponding index indicates an entry in the perceptron table; and
determining a corresponding tag matching result, wherein the corresponding tag matching result indicates a tag match if the corresponding tag matches a tag of the entry indicated by the corresponding index or no tag match if the corresponding tag does not match the tag of the entry indicated by the corresponding index; and
determining the perceptron based on the plurality of tag matching results.

4. The computer-implemented method according to claim 3, wherein if only one perceptron table has a tag matching result indicating a tag match, the perceptron is determined from the only one perceptron table.

5. The computer-implemented method according to claim 3, wherein if two or more perceptron tables have a tag matching result indicating a tag match, the perceptron is determined from a perceptron table with a highest branch history length in the two or more perceptron tables.

6. The computer-implemented method according to claim 1, wherein after a direction of the branch is determined, the method further comprises:
updating the weights of the perceptron stored in the first perceptron table based on the determined branch direction, the branch prediction, and a training threshold; and
creating a new perceptron in response to a grouping condition being satisfied.

7. The computer-implemented method according to claim 6, wherein creating the new perceptron comprises:
creating the new perceptron in a different perceptron table having a non-zero-length tag if the first perceptron table has a zero-length tag; or
creating the new perceptron in a different perceptron table with a branch history length that is higher than a branch history length of the first perceptron table, if the first perceptron table has a non-zero-length tag.

8. One or more non-transitory computer-readable media coupled to one or more processors and having instructions stored thereon which, when executed by the one or more processors, cause the one or more processors to perform operations comprising:
storing, in a memory, a plurality of perceptron tables, wherein each perceptron table of the plurality of perceptron tables has a different branch history length and a different tag length;
determining, based on a branch program counter (PC) and a branch history and from among the plurality of perceptron tables, a perceptron stored in a first perceptron table;
obtaining weights of the perceptron stored in the first perceptron table;
determining, based on the weights and the branch history, a branch prediction, wherein the branch prediction indicates a prediction of a direction that a branch will take upon instruction execution; and
obtaining one or more instructions based on the predicted direction.

9. The non-transitory computer-readable media according to claim 8, wherein one of the plurality of perceptron tables has a zero-length tag, and all other perceptron tables have non- zero-length tags.

10. The non-transitory computer-readable media according to claim 8, wherein determining the perceptron comprises:
for each perceptron table of the plurality of perceptron tables:
generating, based on the branch PC and the branch history, a corresponding index and a corresponding tag, wherein the corresponding index indicates an entry in the perceptron table; and
determining a corresponding tag matching result, wherein the corresponding tag matching result indicates a tag match if the corresponding tag matches a tag of the entry indicated by the corresponding index or no tag match if the corresponding tag does not match the tag of the entry indicated by the corresponding index; and
determining the perceptron based on the plurality of tag matching results.

11. The non-transitory computer-readable media according to claim 10, wherein the corresponding tag generated for the perceptron table with the zero-length tag is zero.

12. The non-transitory computer-readable media according to claim 8, wherein after a direction of the branch is determined, the operations further comprise:
updating the weights of the perceptron stored in the first perceptron table based on the determined branch direction, the branch prediction, and a training threshold; and
creating a new perceptron in response to a grouping condition being satisfied.

13. The non-transitory computer-readable media according to claim 8, the operations further comprise:
relocating, based on a number of the weights of the perceptron, the perceptron to a different perceptron table with a branch history length that is lower than a branch history length of the first perceptron table.

14. A system, comprising:
one or more processors; and
one or more non-transitory computer-readable media coupled to the one or more processors and having instructions stored thereon which, when executed by the one or more processors, cause the one or more processors to perform operations comprising:
storing, in a memory, a plurality of perceptron tables, wherein each perceptron table of the plurality of perceptron tables has a different branch history length and a different tag length;
determining, based on a branch program counter (PC) and a branch history and from among the plurality of perceptron tables, a perceptron stored in a first perceptron table;
obtaining weights of the perceptron stored in the first perceptron table;
determining, based on the weights and the branch history, a branch prediction, wherein the branch prediction indicates a prediction of a direction that a branch will take upon instruction execution; and
obtaining one or more instructions based on the predicted direction.

15. The system according to claim 14, wherein one of the plurality of perceptron tables has a zero-length tag, and all other perceptron tables have non-zero-length tags.

16. The system according to any one of claim 14, wherein determining the perceptron comprises:
for each perceptron table of the plurality of perceptron tables:
generating, based on the branch PC and the branch history, a corresponding index and a corresponding tag, wherein the corresponding index indicates an entry in the perceptron table; and
determining a corresponding tag matching result, wherein the corresponding tag matching result indicates a tag match if the corresponding tag matches a tag of the entry indicated by the corresponding index or no tag match if the corresponding tag does not match the tag of the entry indicated by the corresponding index; and
determining the perceptron based on the plurality of tag matching results.

17. The system according to claim 16, wherein if only one perceptron table has a tag matching result indicating a tag match, the perceptron is determined from the only one perceptron table.

18. The system according to claim 16, wherein if two or more perceptron tables have a tag matching result indicating a tag match, the perceptron is determined from a perceptron table with a highest branch history length in the two or more perceptron tables.

19. The system according to any one of claim 14, wherein after a direction of the branch is determined, the operations further comprise:
updating the weights of the perceptron stored in the first perceptron table based on the determined branch direction, the branch prediction, and a training threshold; and
creating a new perceptron in response to a grouping condition being satisfied.

20. The system according to claim 19, wherein creating the new perceptron comprises:
creating the new perceptron in a different perceptron table having a non-zero-length tag if the first perceptron table has a zero-length tag; or
creating the new perceptron in a different perceptron table with a branch history length that is higher than a branch history length of the first perceptron table, if the first perceptron table has a non-zero-length tag.
